(19) United States
(12) Patent Application Publication
(10) Pub. No.: US 2003/0128419 A1
(43) Pub. Date: Jul. 10, 2003

(54) Stability of a fiber amplifier by eliminating optical feedback into its pumb light sources

(76) Inventors: Sami D. Alaruri, Corning, NY (US); Douglas L. Butler, Painted Post, NY (US); Uta B. Goers, Campbell, NY (US); Paul A. Jakobson, Big Flats, NY (US); Mark A. Summa, Painted Post, NY (US)

Correspondence Address: CORNING INCORPORATED, SP-TI-3-1, CORNING, NY, 14831

(21) Appl. No.: 10/044,705

(22) Filed: Jan. 9, 2002

(51) Int. Cl. H01S 3/00

(52) U.S. Cl. 359/341.3

(57) ABSTRACT

An optical amplifier including a gain fiber, first and second sources of pump light for providing pump light through the gain fiber, first and second optical couplers coupling the first and second sources of pump light to different points along the gain fiber, and a cut-off filter coupled to one or the other of the first and second optical connections for preventing pump light generated by one of the sources from reflecting off the second of the sources and reentering the first source. The gain fiber also includes dopant atoms such as erbium. The cut-off filter is preferably one of a wavelength division multiplexer and an optical isolator.

### BACKGROUND OF THE INVENTION

1. Field of the Invention

The present invention is directed to optical amplifiers. In particular, the present invention is directed to an optical amplifier that eliminates spikes from the emission spectrum.

2. Description of Related Art

An optical amplifier, in particular, a two-stage Er-fiber amplifier that utilizes 980 nm and 1480 nm laser pumps was evaluated for performance and the emission spectrum of such an optical amplifier was carefully studied by the present inventors. Emission spikes were observed by the present inventors in the output spectra of 025× unstable two-stage Er-fiber amplifiers. Such emission spikes were not observed in the emission spectra for a similar amplifier architecture that utilizes laser pumps operating at different wavelengths. Prior to the present invention as described in detail below, the root cause and the solution to eliminate the emission spikes were not known.

### SUMMARY OF THE INVENTION

In view of the observed spikes in the emissions spectrum, the root cause of such spikes were investigated by the present inventors. Experiments conducted with wrapped and unwrapped fibers in a two-stage Er-fiber amplifier that utilizes 980 nm and 1480 nm laser pumps indicated that the generation of these spikes is dependent on 1) polarization state of the signal; and 2) on the driving current of the 980 nm laser pump. More specifically, the present applicants found that the root cause of the emission spikes in the output spectrum was attributable to instabilities in the laser pump that utilizes 980 nm wavelength. This instability was found to be caused by 980 nm wavelength pump light that is reflected from the 1480 nm laser pump back into the 980 nm laser pump's laser cavity.

In view of the foregoing, the primary advantage of the present invention is in providing an optical amplifier which substantially eliminates the emission spikes in the output spectrum.

Another advantage of the present invention is in providing an optical amplifier which prevents pump light from reflecting back to the source of the pump light.

Still another advantage of the present invention is in providing a two-stage Er-fiber amplifier that utilizes 980 nm and 1480 nm laser pumps with minimal emission spikes.

These and other advantages are attained by an optical amplifier in accordance with the present invention including a gain fiber, first and second sources of pump light for providing pump light through the gain fiber, first and second optical couplers coupling the first and second sources of pump light to different points along the gain fiber, and a cut-off filter coupled to one or the other of the first and second optical connections for preventing pump light generated by one of the sources from reflecting off the second of the sources and reentering the first source.

In accordance with one embodiment, the first and second optical couplers are three port couplers. The gain fiber also includes dopant atoms, and the pump light sources raise the atoms to an excited state. In this regard, the dopant atoms include erbium. In another embodiment, the pump light sources raise the dopant atoms to different states of excitation. In one embodiment, the first pump light sources raises the dopant atoms to a first state of excitation while the second pump light raises the dopant atoms to a second state of excitation that is higher than the first state. In this regard, the first pump light source provides light having a wavelength that is shorter than the wavelength of light provided by the second pump light source in another embodiment. Moreover, the wavelength of light from the first and second sources is about 980 nm and 1480 nm, respectively in one embodiment. In still another embodiment, the first coupler couples a signal light to the first source of pump light, and the second coupler couples the second source of pump light to the gain fiber and includes an exit port for the signal light

In accordance with yet another embodiment of the present invention, the first and second sources of pump light are connected to the gain fiber via first and second optical fibers, respectively. In such an embodiment, the cut-off filter is connected to either the second optical fiber or the first optical fiber. In accordance with still another embodiment, the cut-off filter is one of a wavelength division multiplexer (WDM) and an optical isolator.

In accordance with another embodiment of the present invention, the first and second sources of pump light provide co-propagating pump light while in another embodiment, the first and second pump light sources provide opposing beams of light in the gain fiber. In another embodiment, each of the optical couplers is a wavelength division multiplexer and the filter is a wavelength division multiplexer or an optical isolator. In one embodiment, the pump sources each include a laser, and the cut-off filter prevents laser light generated by the first pump laser from reflecting back to the first pump laser from the second pump laser.

In accordance with yet another embodiment of the present invention, 980 nm and 1480 nm sources of pump light are connected to opposite ends of the gain fiber via first and second wavelength division multiplexers. In addition, the cut-off filter is located between one of the sources of pump light and one of the wavelength division multiplexers.

These and other advantages and features of the present invention will become more apparent from the following detailed description of the preferred embodiments of the present invention when viewed in, conjunction with the accompanying drawings.

### BRIEF DESCRIPTION OF THE DRAWINGS

FIG. 1 is a schematic illustration of an optical amplifier in accordance with one embodiment of the present invention which minimizes the emission spikes in the output spectrum.

FIG. 2 is an example of an optical amplifier in accordance with one embodiment of the present invention including a cut-off filter which is a WDM.

FIG. 3 is an example of an optical amplifier in accordance with one embodiment of the present invention including a cut-off filter which is an optical isolator.

FIG. 4 is a graph showing the emission spikes in the output spectrum of an optical amplifier that does not have the cut-off filter in accordance with the present invention.

FIG. 5 is a graph showing the emission spikes in the output spectrum of an optical amplifier that includes the cut-off filter in accordance with the present invention.

### DETAILED DESCRIPTION OF THE PREFERRED EMBODIMENT

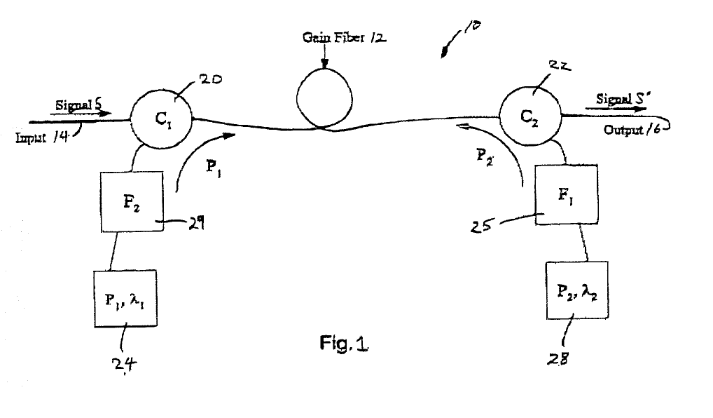

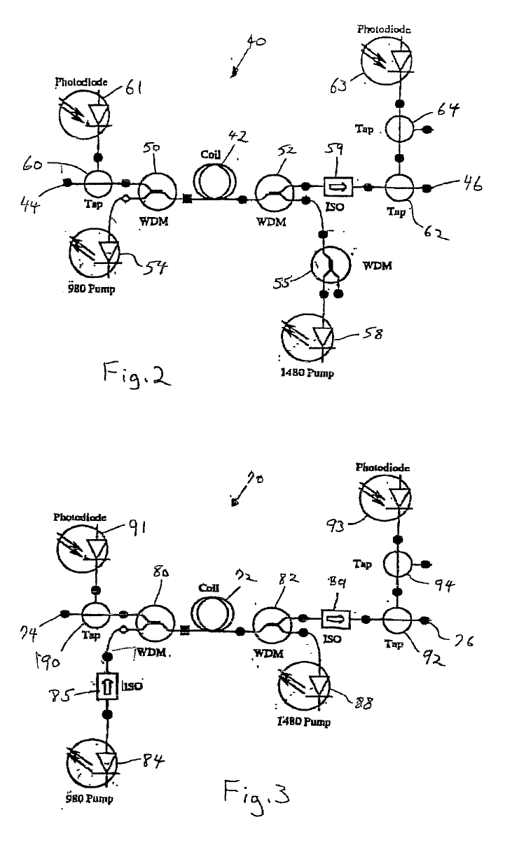

As will be apparent from the discussion herein below, FIG. 1 shows a schematic illustration of an optical amplifier 10 in accordance with one embodiment of the present invention which substantially eliminates the emission spikes in the 10 output spectrum. As will be evident from the discussion below, the optical amplifier prevents pump light from reflecting back to the source of the pump light. It should initially be noted that FIG. 1 shows a general example of one preferred embodiment of the present invention which may be applied to various optical amplifiers having different specifications and additional components. In this regard, specific examples are also discussed below relative to FIGS. 2 and 3.

As can be seen, the optical amplifier 10 in accordance with the illustrated embodiment includes a gain fiber 12 which may be a wrapped or an unwrapped optical fiber. In this regard, the gain fiber 12 in the illustrated embodiment is an Er-fiber which is erbium doped. The gain fiber 12 is connected to an input 14 for conveying the optical signal S into the optical amplifier 10 and an output 16 for allowing output of the amplified signal S′ preferably in the direction shown. In this regard, the gain fiber 12 is connected to the input 14 at one end via first optical coupler 20 (also designated C₁) and is connected to the output 16 at the other end via second optical coupler 22 (also designated C₂).

The optical amplifier 10 includes a first source 24 of pump light P₁ and a second source 28 of pump light P₂. In this regard, the first source 24 operates at wavelength λ₁ and is adapted to provide pump light P₁ through the gain fiber 12. In a similar manner, the second source 28 operates at wavelength λ₂ which is preferably different from wavelength λ₁, and is adapted to provide pump light P₂ through the gain fiber 12. Thus, the first and second optical couplers 20 and 22 couple the first and second sources 24 and 28 of pump light to different points along the gain fiber 12. In this regard, the first and second sources 24 and 28 of pump light may include lasers such as pump lasers known in the optic arts. Moreover, in the illustrated embodiment of the present invention, the pump lights P₁ and P₂ of the first and second sources 24 and 28, respectively, are preferably provided to the gain fiber 12 in opposing directions as shown. Of course, in other embodiments of the present invention, the first and second sources 24 and 28 of pump light may provide co-propagating pump light instead.

As previously explained, the present inventors found that the emission spikes in the output spectrum are caused by pump light of a first source being reflected from a second source back into the first source. Thus, in FIG. 1, the pump light P₁ from first source 24 is introduced into the gain fiber 12 through the first optical coupler 20. Upon reaching the second source 28 via the second optical coupler 22, a small portion of pump light P₁ is reflected back toward the first optical coupler 20 and re-enters the first source 24. When this occurs, instability in the first source 24 occurs which causes spikes in the output spectrum of the optical amplifier 10. In a similar manner, pump light P₂ from the second source 28 is introduced into the gain fiber 12 through the second optical coupler 22. Upon reaching the first source 24 via the first optical coupler 20, a small portion of pump light P₂ is reflected back toward the second optical coupler 22 and re-enters the second source 28, which causes instability in the second source 28 and spikes in the output spectrum of the optical amplifier 10 occur.

To prevent pump light from reflecting back into the first and second sources 24 and 28 in the manner described above, the optical amplifier 10 in accordance with the illustrated embodiment of the present invention is provided with a first cut-off filter 25 and a second cut-off filter 29 (also designated F₁ and F₂, respectively) that operate to prevent such reflection of pump light thereby substantially eliminating the emission spikes in the output spectrum of the optical amplifier 10. In the illustrated embodiment, the first cut-off filter 25 is provided between the second source 28 and the second optical coupler 22 so that any reflected pump light P₁ provided by the first source 24 is prevented from reflecting off the second source 28 and reentering the first source 24. In a similar manner, the second cut-off filter 29 is provided between the first source 24 and the first optical coupler 20 so that any reflected pump light P₂ provided by the second source 28 is prevented from reflecting off the first source 24 and reentering the second source 28. In one embodiment of the present invention, the first and second cut-off filters 25 and 29 are wavelength division multiplexers (WDM) and/or optical isolators (ISO).

It should be noted that whereas in the illustrated embodiment of FIG. 1, the optical amplifier 10 is provided with first and second cut-off filters 25 and 29 that are adapted to prevent pump light from reflection and reentering both the first and second sources 24 and 28, only one of the cut-off filters is needed to practice the present invention. Whether one or more cut-off filters are provided depends largely on the characteristics of the optical amplifier to which the present invention is applied and the root cause for emission spikes in the output spectrum of the optical amplifier. In certain optical amplifier designs to which the present invention is applied, the emission spikes in the output spectrum may be caused by instability of only one of many sources in the amplifier. In such an instance, only one cut-off filter may be provided to prevent the reflection of pump light that causes the instability of a corresponding source of pump light. For instance, in other embodiments, only the first cut-off filter 25 may be provided to prevent pump light Pi from being reflected off the second source 28 and reentering the first source 24.

Moreover, in other embodiments of the present invention, the cut-off filters may be provided at different locations in the optical amplifier than those shown in FIG. 1. For instance, in other embodiments, a cut-off filter may be provided between the second optical coupler 22 and the output 16 instead of, or in addition to, the first cut-off filter 25. Such positioned cut-off filter will prevent any pump light P₁ that may be reflected by any optical components downstream of the second optical coupler 22 back to the first source 24. Alternatively, one cut-off filter may be provided before the second optical coupler 22. This location is especially advantageous in that in addition to preventing pump light P₁ from being reflected off the second source 28, it also prevents any pump light P₁ that may be reflected off any optical components downstream of the second optical coupler 22 back to the first source 24 as well. Likewise, cut-off filter(s) may be appropriately positioned to address any reflection of pump light P₂ as well. However, consideration should be given to the fact that providing such cut-off filters in the path of the signal S may effect the gain characteristics of the amplifier 10 and may not be desirable in certain applications.

FIG. 2 illustrates an example of an optical amplifier 40 in accordance with one embodiment of the present invention. As can be seen, the optical amplifier 40 includes a gain fiber, which is shown as coil 42. In this regard, the coil 42 is a two-stage Er-fiber which is erbium doped. The coil 42 is connected to an input 44 and an output 46 for allowing input and output of an optical signal. In this regard, the coil 42 is optically connected to the input 44 at one end via a first optical coupler 50, which in the present embodiment is a wavelength division multimplexer (WDM), and is connected to the output 46 at the other end via a second optical coupler 52, which is also a WDM. As can be seen, the first and second optical couplers 50 and 52 of the illustrated embodiment are both three port couplers which are connected in the manner shown.

The optical amplifier 40, as shown in FIG. 2, also includes a first source 54 of pump light which is optically connected to the coil 42 via the first optical coupler 50 and includes a second source 58 of pump light optically connected to the coil 42 via the second optical coupler 52. Of course, other appropriate optical components such as optical fibers may be used as well to facilitate the optical connections described. In the illustrated example of FIG. 2, the wavelength of the first source 54 is shorter than the wavelength of the second source 58. Both sources provide corresponding pump light to the coil 42 in opposite directions. In this regard, in the illustrated example, the first source 54 of pump light operates at a wavelength of 980 nm and the second source 58 of pump light operates at a wavelength of 1480 nm. The first source 54 of pump light and the second source 58 of pump light are operable to raise the dopant atoms of the coil 42 to different states of excitation. In this regard, the second source 58 of pump light raises the dopant atoms to a second state of excitation which is higher than a first state of excitation attained by the first source 54. Moreover, as previously noted, the first and second sources 54 and 58 of pump light may include lasers such as pump lasers known in the optic arts.

To prevent the 980 nm pump light provided by the first source 54 from being reflected off the second source 58 back into the first source 54 and causing emission spikes in the output spectrum in the manner previously described, the optical amplifier 40 in accordance with the illustrated embodiment of the present invention is provided with a cut-off filter 55. In the illustrated embodiment, the cut-off filter 55 is provided between the second source 58 and the second optical coupler 52 so that any reflected pump light provided by the first source 54 is prevented from reflecting off the second source 58 and reentering the first source 54. As can also be seen, the cut-off filter 55 is a wavelength division multiplexer (WDM) with one of the ports being unused. The optical amplifier 40 as shown in FIG. 2 also includes an optical isolator 59 provided after the second coupler 52, which further aids in eliminating the spikes in the output spectrum by preventing reflection of pump light off any components downstream of the optical amplifier 40 and reentering back into the first source 54.

The optical amplifier 40 as shown in FIG. 2 further includes various other optional optical components that enhance the utility of the optical amplifier 40. As can be seen, the optical amplifier 40 is provided with numerous taps such as taps 60, 62, and 64. The tap 60 provides optical connection of photodiode 61 to the input 44 to allow monitoring of the optical signal prior to amplification. In a similar manner, tap 62 provides connection of photodiode 63 to the output 46 to allow monitoring of the optical signal subsequent to amplification. As can be appreciated, this allows monitoring of the performance of the optical amplifier 70. Moreover, the optical amplifier 40 incudes another tap 64 between the tap 62 and photodiode 63 which is not used in the illustrated embodiment but may be used for some other purpose.

FIG. 3 illustrates another example of an optical amplifier 70 in accordance with one embodiment of the present invention which is similar to the embodiment shown in FIG. 2. As can be seen, the optical amplifier 70 includes a gain fiber which is shown as coil 72 which, like the previous embodiment, is a two-stage Er-fiber. The coil 72 is connected to an input 74 and an output 76 via a first optical coupler 80 and second optical coupler 82 which in the present embodiment, are wavelength division multiplexers (WDM) connected in the manner shown. The optical amplifier 70 as shown in FIG. 3 also includes a first source 84 of pump light optically connected to the coil 72 via the first optical coupler 80, and a second source 88 of pump light optically connected to the coil 72 via the second optical coupler 82. Like the prior example, the first source 84 of pump light operates at a wavelength of 980 nm and the second source 88 of pump light operates at a wavelength of 1480 nm, with the second source 88 of pump light raising the dopant atoms to a second state of excitation that is higher than a first state of excitation attained by the first source 84.

To prevent the 1480 nm pump light provided by the second source 88 from being reflected off the first 84 of pump light back into the second source 88 and causing emission spikes in the output spectrum in the manner previously described, the optical amplifier 70 is provided with a cut-off filter 85. In the illustrated embodiment, the cut-off filter 85 is provided between the first source 84 and the first optical coupler 80 so that any pump light provided by the second source 88 is prevented from reflecting off the first source 84 and reentering the second source 88. As can also be seen, unlike the prior example, the cut-off filter 85 is an optical isolator. Also like the prior embodiment of FIG. 3, the optical amplifier 70 also includes an optical isolator 89 provided after the second coupler 82 which further aids in eliminating spikes in the output spectrum in the manner previously described. The optical amplifier 70 as shown in FIG. 3 further includes various other optical components that enhance the utility such as taps 90, 92, and 94, as well as photodiodes 91 and 93 which allow monitoring of the optical signal and the performance of the optical amplifier 70 in a similar manner to the embodiment described above.

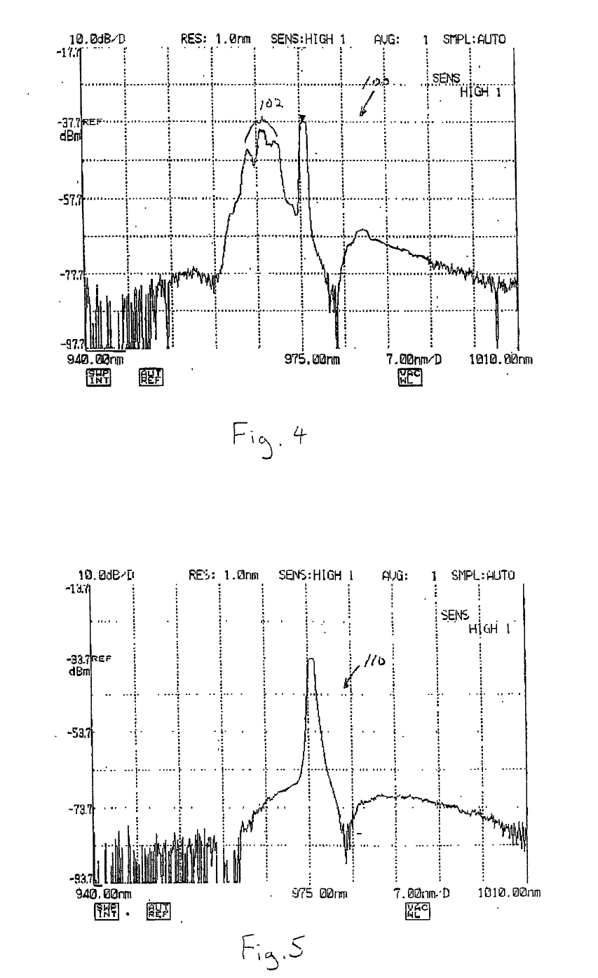

FIG. 4 is noted for showing graph 100 which is an output from an Optical Spectrum Analyzer (OSA) that illustrates emission spikes 102 in a sample output spectrum of an example optical amplifier (not shown) that does not have the cut-off filter feature in accordance with the present invention as described above. As previously described, the spikes 102 have been found to be caused by instabilities in the first source of the optical amplifier which is caused by the reflected light as described above.

In contrast, FIG. 5 shows graph 110 which is also an output from an OSA that illustrates a sample output spectrum of an example optical amplifier (not shown) that includes the cut-off filter in accordance with the present invention as described above. In particular, a WDM was installed prior to the 1480 nm source in a manner as shown in FIG. 2 to thereby eliminate the spikes 102 shown in FIG. 4 which were found to be caused by the reflected light. As can be seen, a more desirable output spectrum was provided by practicing the present invention. Of course, it should be noted that the graph 100 shown in FIG. 4 and the graph 110 shown in FIG. 5 which includes the cut-off filter of the present invention are provided merely as examples and the present invention is not limited thereto.

While various embodiments in accordance with the present invention have been shown and described, it is understood that the invention is not limited thereto. The present invention may be changed, modified and further applied by those skilled in the art. Therefore, this invention is not limited to the details shown and described previously, but also includes all such changes and modifications.

What is claimed:

1. An optical amplifier, comprising:
a gain fiber;
first and second sources of pump light for providing pump light through said gain fiber in opposite directions;
first and second optical couplers, said couplers coupling said first and second sources of pump light to different points along said gain fiber, and
a cut-off filter coupled to one or the other of said first and second optical connections for preventing pump light generated by one of said sources from reflecting off the second of said sources and reentering said first source.

2. An optical amplifier according to claim 1, wherein said first and second optical couplers are three port couplers.

3. The optical amplifier according to claim 1, wherein said gain fiber includes dopant atoms, and said pump light sources raise said atoms to an excited state.

4. The optical amplifier according to claim 3, wherein said dopant atoms include erbium.

5. The optical amplifier according to claim 3, wherein said pump light sources raise said dopant atoms to different states of excitation.

6. The optical amplifier according to claim 3, wherein said first pump light source raises said dopant atoms to a first state of excitation while said second pump light source raises said dopant atoms to a second state of excitation that is higher than said first state.

7. The optical amplifier according to claim 6, wherein said first pump light source provides light having a wavelength that is shorter than wavelength of light provided by said second pump light source.

8. The optical amplifier according to claim 7, wherein said dopant atoms are erbium, and the wavelength of light from said first and second sources are about 980 and 1480 nm, respectively.

9. The optical amplifier according to claim 7, wherein said first coupler couples a signal light to said first source of pump light, and said second coupler couples said second source of pump light to said gain fiber and includes an exit port for said signal light.

10. The optical amplifier according to claim 1, wherein said first and second sources of pump light are connected to said gain fiber via first and second optical fibers, respectively.

11. The optical amplifier according to claim 10, wherein said cut-off filter is connected to said second optical fiber.

12. The optical amplifier according to claim 10, wherein said cut-off filter is connected to said first optical fiber.

13. The optical amplifier according to claim 1, wherein said cut-off filter is one of a wavelength division multiplexer and an optical isolator.

14. An optical amplifier, comprising:
a gain fiber including a dopant;
first and second sources of pump light for providing pump light of different wavelengths through said gain fiber;
first and second optical couplers, said couplers coupling said first and second sources of pump light to different points along said gain fiber, and
a cut-off filter coupled to one or the other of said first and second optical connections for preventing pump light generated by one of said sources from reflecting off the other of said sources and reentering said one source.

15. The optical amplifier according to claim 14, wherein said first and second sources of pump light provide co-propagating pump light.

16. The optical amplifier according to claim 14, wherein the wavelength of said first pump light source is shorter than the wavelength of said second pump light source.

17. The optical amplifier according to claim 14, wherein said first and second pump light sources provide opposing beams of light in said gain fiber.

18. The optical amplifier according to claim 14, wherein said dopant is erbium, and the wavelength of light from said first and second sources are about 980 and 1480 nm, respectively.

19. The optical amplifier according to claim 14, wherein each of said optical couplers is a wavelength division multiplexer.

20. The optical amplifier according to claim 14, wherein said filter is a wavelength division multiplexer.

21. The optical amplifier according to claim 14, wherein said filter is an optical isolator.

22. The optical amplifier according to claim 14, wherein said pump sources each include a laser, and said cut-off filter prevents laser light generated by said first pump laser from reflecting back to said first pump laser from said second pump laser.

23. The optical amplifier, comprising:
an erbium doped gain fiber;
980 nm and 1480 nm sources of pump light;
first and second wavelength division multiplexers for connecting said 980 nm and 1480 nm sources of pump light to opposite ends of said gain fiber, and
a cut-off filter connected to one of said first and second wavelength division multiplexers for preventing pump light generated by said 980 nm pump light source from reflecting off said 1480 nm pump light source and reentering said 980 nm pump light source.

24. The optical amplifier according to claim 23, wherein said cut-off filter is located between one of said sources of pump light and one of said wavelength division multiplexers.

25. The optical amplifier according to claim 23, wherein said cut-off filter is one of a wavelength division multiplexer and an optical isolator.
